(19) United States
(12) Patent Application Publication
(10) Pub. No.: US 2018/0255168 A1
(43) Pub. Date: Sep. 6, 2018

(54) Method And System For Semantic Visual Communication

(71) Applicant: Michael Callahan, San Francisco, CA (US)

(72) Inventor: Michael Callahan, San Francisco, CA (US)

(21) Appl. No.: 15/911,373

(22) Filed: Mar. 5, 2018

Related U.S. Application Data
(60) Provisional application No. 62/466,791, filed on Mar. 3, 2017.

(51) Int. Cl. H04M 1/725; H04L 12/58; H04W 4/12; G06F 3/0488; G06F 3/0481; G06F 17/27

(52) U.S. Cl. CPC H04M 1/72552; H04L 51/10; H04W 4/12; H04M 1/72544; H04L 51/063; G06F 3/04812; G06F 17/2785; G06F 3/04883

(57) ABSTRACT

Methods and systems for semantic visual communication may include in a handheld communication device including a user input mechanism, a processor, and a display: receiving textual information via said user input mechanism in the handheld communication device; analyzing the textual information using the processor and one or more algorithms; generating meta information based on the analysis; and providing semantic visual information content on the display based on the meta information for selection by a user. The user input mechanism may comprise a touchscreen display. The semantic visual information may comprise a looping visual or a static image, and may be provided from a content library stored on the handheld communication device or stored on a device wirelessly coupled to the handheld device. Selected semantic visual information may be modified based on received user input. The modifying may comprise incorporating the received textual information into the selected semantic visual information.

### CROSS-REFERENCE TO RELATED APPLICATIONS/INCORPORATION BY REFERENCE

This application claims priority to and the benefit of U.S. Provisional Application 62/466,791 filed on Mar. 3, 2017, which is hereby incorporated herein by reference in its entirety.

### TECHNICAL FIELD

Aspects of the present disclosure relate to displaying information. More specifically, certain implementations of the present disclosure relate to methods and systems for semantic visual communication.

### BACKGROUND

Conventional approaches for visual communication may be costly, cumbersome, and/or inefficient—e.g., they may be complex and/or time consuming.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

System and methods are provided for semantic visual communication, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating handheld communication device, in accordance with an example embodiment of the disclosure.

FIG. 2 is a block diagram illustrating automated semantic visual retrieval, in accordance with an example embodiment of the disclosure.

FIG. 3 is a flow chart for semantic visual communication, in accordance with an example embodiment of the disclosure.

### DETAILED DESCRIPTION OF THE INVENTION

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry or a device is “operable” to perform a function whenever the circuitry or device comprises the necessary hardware and code (if any is necessary) to perform the function, regardless of whether performance of the function is disabled or not enabled (e.g., by a user-configurable setting, factory trim, etc.).

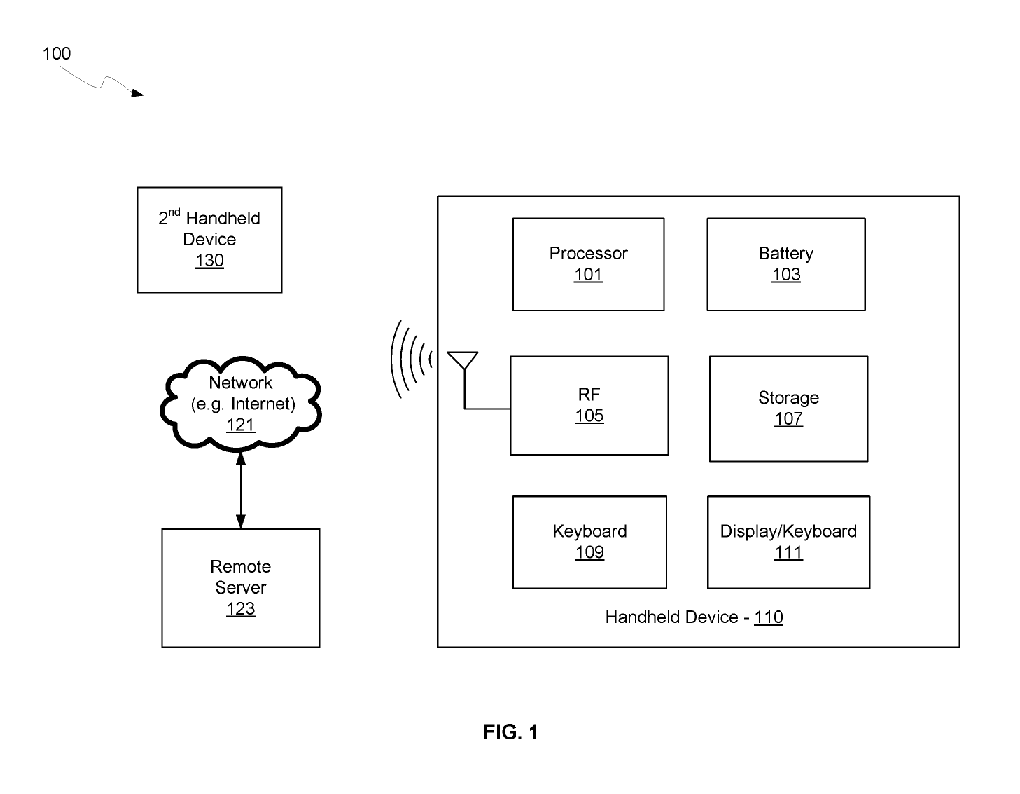

FIG. 1 is a diagram illustrating handheld communication device, in accordance with an example embodiment of the disclosure. Referring to FIG. 1, there is shown a communication system 100 with a handheld device 110, a network 121, an optional remote server 123, and a 2^{nd} handheld device 130. The handheld device 110 may comprise any device used for communication such as a cell phone, tablet, or laptop, for example, with computing and storage capability, although some of such capability may be performed by other devices in communication with the handheld device 110.

The handheld device 110 may comprise a processor 101, a battery 103, a wireless radio frequency (RF) front end 105, storage 107, an optional physical keyboard, and a display 111, which may provide the keyboard for the handheld device 110 if no physical keyboard.

The processor 101 may control the operations of the handheld device 110, storing information in the storage 107, enabling communications via the RF front end 105, processing information received via the keyboard, and other suitable control operations for the handheld device 110. The battery 103 may provide power for the handheld device 110 and the storage 107 may comprise a memory device for storing information. In an example scenario, the storage 107 may store visual image files, or small looping visuals, sometimes referred to as “GIFs” despite typically not being in GIF file format. Furthermore, the visuals do not necessarily loop, but may instead be static images or other type of expressive visual content.

The RF front end 105 may comprise suitable circuitry for communicating wirelessly with other devices via one or more networks, such as the network 121. The RF front end 105 may therefore communicate utilizing various communications standards, such as GSM, CDMA, WiFi, Bluetooth, Zigbee, etc., and therefore may comprise one or more antennae, filters, amplifiers, mixers, and analog-to-digital converters, for example.

The handheld device 110 may comprise a physical keyboard 109, a touchscreen keyboard 111, or both, for entering information, such as through text messaging. The keyboard may provide directional swiping and/or swiping from keyboard to device camera.

The network 121 may comprise any communication by which the handheld device communicates with other devices, such as the remote server 123 and the 2^{nd} handheld device 130. As such, the network 121 may comprise the Internet, a local WiFi network, one or more cellular networks, etc.

The remote server 123 may comprise a computing device or devices for assisting in semantic visual messaging and may comprise a database of visual image files, or small looping visuals that may be utilized for communicating messages from the handheld device 110. The remote server may be optional in instances when the database is stored locally on the handheld device 130.

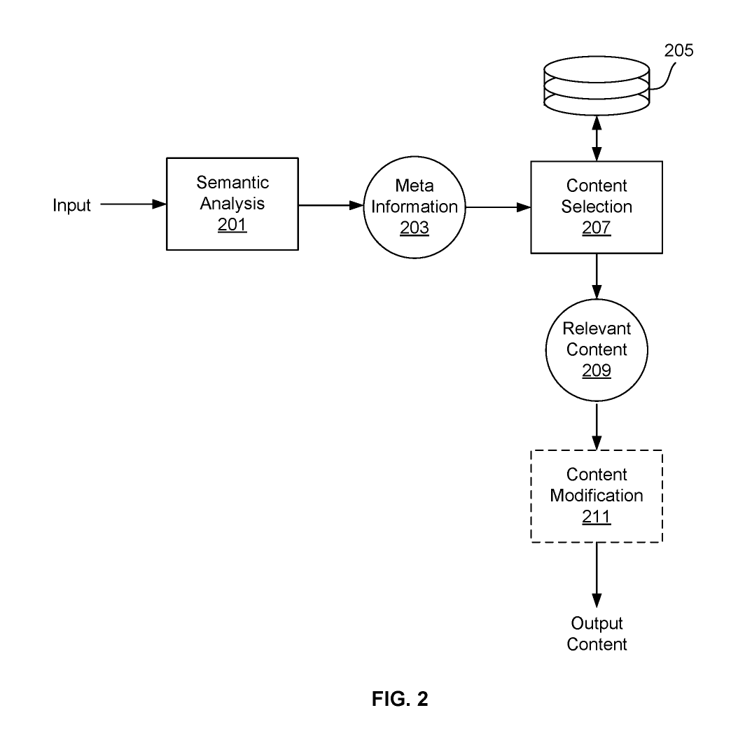

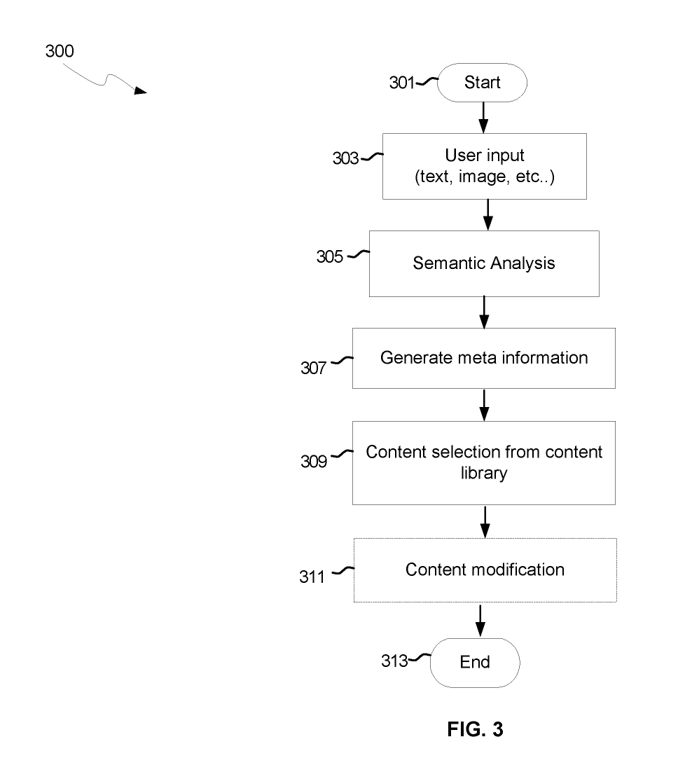

These small looping visuals, stored locally in the storage 107 and/or remotely in the remote server 123, may be utilized for semantic visual messaging in that a message typed in by a user of the handheld device 110 may be analyzed semantically to determine an idea or theme being communicated. This analysis may be performed locally by the processor 101 using semantics algorithms or may utilize assistance from remote processors, such as in the remote server 123, for example, and may result in suggested small looping visuals that may then be automatically selected or may provide a number of choices for the user to select to then be included in a message to a recipient. This is shown further with respect to FIGS. 2 and 3.

FIG. 2 is a block diagram illustrating automated semantic visual retrieval, in accordance with an example embodiment of the disclosure. Referring to FIG. 2, there is shown a semantic analysis block 201, resulting meta information 203, a content library 205, a content selection block 207, resulting relevant content 209, and optional content modification block 211.

The semantic analysis block 201 may comprise one or more algorithms for language processing to extract relevant information about the message being communicated. In an example scenario, data may be entered, such as text via the keyboard, an inserted image, etc., where semantic analysis, or visual analysis in the case of an image, may be performed on the input to produce meta information 203 related to the input. In an example scenario, if a user typed “I want chocolate cake for my birthday,” the semantic analysis may result in meta information such as “party,” “chocolate cake,” the person's birthdate, and “happy,” for example, although many more items may be determined, depending on the message and other factors such as prior messaging history, intended recipient, time of day, user interests, or other contextual information. This meta information 203 may be utilized by the content selection block 207 to select one or more semantic visual messages from the content library 205. For example, the content selection block 207 may select a small looping visual of a child eating a chocolate cake with frosting all over his face, which gives much richer communication than just text messages or emojis.

The content library 205 may comprise a database of small looping visuals with associated meta information that may assist in selecting appropriate visuals for an input text message. The content library 205 may be remote, local, or a combination of the two. For example, a wireless device may store a portion of the content library 205 for common themes or common messages entered by the user, while a larger portion of the content library may be on a remote server, such as the remote server 123.

The content library 205 may also include personalized content including emojis, pictures, and/or videos which are generated using precise visual information from a user's face, body, and/or characteristics. This content is created by first extracting information from visual content of the user. This information is then processed by a neural network software in order to create digital content with the user's likeness. Optionally, the user may add to, replace, or refine the content created by the software.

The relevant content 209 may comprise one or more small looping visuals selected by the content selection block 207. In instances where a plurality of visuals are selected and presented to the user, the user may pick a preferred visual to be sent.

In addition, an optional modification of the content may be performed by the content modification block 211, where the entered text, for example, may be incorporated into the visual content, or modify the content in other ways. In other example scenarios, the visual content may be sent without the entered text, with the text over the visual content, or animated into the visual content. Finally, the resulting content, e.g., the visual and original text, may be sent via the device to an intended recipient. The visual content is sometimes referred to as “GIFs,” although they may not actually be GIFs as they are typically not in GIF format when utilized but are typically compressed to MP4 format. This provides an improvement to communication via a handheld device in that a deeper level of information may be conveyed above and beyond text and emojis and improves the ease in which such information can be provided.

FIG. 3 is a flow chart for semantic visual communication, in accordance with an example embodiment of the disclosure. Referring to FIG. 3, there is shown semantic visual process flow 300 starting with start step 301 followed by step 303 where a message may be input to the device, such as a text message to an intended recipient. In step 305, semantic analysis may be performed on the input data. This may comprise one or more algorithms to be applied to the text, which results in step 307, the generation of meta information, comprising data elements that are relevant to the message. For example, if the text entered included “We're heading to Aspen after Christmas!” the algorithm may generate meta information such as “skiing,” “snow,” “skis,” “lodge,” “excited,” “Christmas tree,” and other relevant information that may more fully convey this message.

In step 309, the meta information may be used to select one or more small looping visuals, which in this case an example could be a skier in Aspen, Colorado doing a skiing trick in a Christmas sweater, a family by a roaring fire and Christmas tree in a ski lodge with ski slopes outside the windows, or other such visual representations of the entered text. In another example scenario, a number of suggested small looping visuals may be provided to the user to select a preferred one.

In optional step 311, the selected looping visual may be modified to personalize the visual or created from combining, modifying, or adding additional assets. For example, the selected looping visual may be modified to include a typed message at the bottom such as “Smith family Christmas in Aspen!” Another possible way to personalize a visual includes modifying the face(s) and/or object(s) in the selected looping visual. For example, the selected looping visual could show a person whose face has been replaced with the face of someone else.

In an example embodiment of the disclosure, a method and system is described for semantic visual communication and comprises in a handheld communication device comprising a user input mechanism, a processor, and a display: receiving textual information via said user input mechanism in said handheld communication device; analyzing the textual information using said processor and one or more algorithms; generating meta information based on the analyzing of the textual information; and providing semantic visual information content on said display based on the meta information for selection by a user. The user input mechanism may comprise a touchscreen display.

The semantic visual information may comprise a looping visual or a static image. The semantic visual information may be provided from a content library stored on said handheld communication device or from a content library stored on a device wirelessly coupled to said handheld communication device. Selected semantic visual information may be modified based on received user input. The modifying may comprise incorporating the received textual information into the selected semantic visual information. The selected semantic visual information may be communicated from the handheld communication device to a second handheld communication device. The meta information may comprise keywords associated with the received textual information.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for providing visual content, the method comprising:
in a handheld communication device comprising a user input mechanism, a processor, and a display:
receiving textual information via said user input mechanism in said handheld communication device;
analyzing the textual information using said processor and one or more algorithms;
generating meta information based on the analyzing of the textual information; and
providing semantic visual information content on said display based on the meta information for selection by a user.

2. The method according to claim 1, wherein said user input mechanism comprises a touchscreen display.

3. The method according to claim 1, wherein said semantic visual information comprises a looping visual.

4. The method according to claim 1, wherein said semantic visual information comprises a static image.

5. The method according to claim 1, comprising providing said semantic visual information from a content library stored on said handheld communication device.

6. The method according to claim 1, comprising providing said semantic visual information from a content library stored on a device wirelessly coupled to said handheld communication device.

7. The method according to claim 1, comprising modifying selected semantic visual information based on received user input.

8. The method according to claim 7, wherein said modifying comprises incorporating said received textual information into said selected semantic visual information.

9. The method according to claim 1, comprising communicating selected semantic visual information from said handheld communication device to a second handheld communication device.

10. The method according to claim 1, wherein the meta information comprises keywords associated with the received textual information.

11. A system for providing visual content to a user, the system comprising:
a handheld communication device comprising a user input mechanism, a processor, and a display, said handheld communication device operable to:
receive textual information via said user input mechanism in said handheld communication device;
analyze the textual information using said processor and one or more algorithms;
generate meta information based on the analyzing of the textual information; and
provide semantic visual information content on said display based on the meta information for selection by a user.

12. The system according to claim 11, wherein said user input mechanism comprises a touchscreen display.

13. The system according to claim 11, wherein said semantic visual information comprises a looping visual.

14. The system according to claim 11, wherein said semantic visual information comprises a static image.

15. The system according to claim 11, wherein said handheld communication device is operable to provide said semantic visual information from a content library stored on said handheld communication device.

16. The system according to claim 11, wherein said handheld communication device is operable to provide said semantic visual information from a content library stored on a device wirelessly coupled to said handheld communication device.

17. The system according to claim 11, wherein said handheld communication device is operable to modify selected semantic visual information based on received user input.

18. The system according to claim 17, wherein said modifying comprises incorporating said received textual information into said selected semantic visual information.

19. The system according to claim 11, wherein said handheld communication device is operable to communicate selected semantic visual information from said handheld communication device to a second handheld communication device.

20. A system for communication, the system comprising:
a wireless communication device comprising a processor, and a touchscreen display comprising a user input mechanism, said handheld communication device operable to:
receive textual information via said user input mechanism in said handheld communication device;
analyze the textual information using said processor and one or more algorithms;
generate meta information based on the analyzing of the textual information; and
provide semantic visual information content on said display based on the meta information for selection by a user.
